(19) United States
(12) Patent Application Publication
(10) Pub. No.: US 2005/0125329 A1
(43) Pub. Date: Jun. 9, 2005

(54) Systems and methods for processing multiple contingent transactions

(75) Inventors: Douglas W. Gerhart, Toronto (CA); Joanna T. Liczyk, Toronto (CA); Douglas E. Steiner, Toronto (CA)

Correspondence Address: Finnegan, Henderson, Farabow,;Garrett & Dunner, L.L.P., 1300 I Street, N.W., Washington, DC, 20005-3315, US

(73) Assignee: NuCenz Technologies, Inc.

(21) Appl. No.: 10/730,023

(22) Filed: Dec. 9, 2003

(51) Int. Cl. G06F 17/60

(52) U.S. Cl. 705/37

(57) ABSTRACT

Systems, methods, and programs consistent with the present invention link markets for different fungible assets and different transaction types, allowing a participant to create and execute contingent orders across markets. Embodiments consistent with the invention provide an automated framework for participants to create a group of discrete orders for different fungible assets in different markets, including markets for different types of transactions. The automated framework manages execution of the group of discrete orders, linking them together in a contingent fashion such that all the discrete orders are filled or none are filled. In one embodiment, the discrete orders are all executed at approximately the same time.

### DESCRIPTION OF THE INVENTION

1. Field of the Invention

This invention generally relates to automated systems for providing linked markets, and more particularly, to systems and methods for contingent rexecution of linked transactions involving fungible assets.

2. Background of the Invention

For thousands of years organized markets have provided efficient means for valuing and exchanging fungible assets. Market design theory teaches that the economic efficiency and practical benefits of a market tend to improve when the fungible assets traded and the transactions conducted in the market are subject to some degree of standardization and regulation. In response to this teaching, most organized markets operating at present conduct transactions only for a narrowly defined set of fungible assets, permit only a defined set of transaction types to occur within the market, and operate according to an extensive set of rules and regulations that all participants agree to abide by. Markets that exhibit these characteristics are typically referred to as exchanges, of which the New York Stock Exchange is an example.

While many classes of fungible assets trade in many different organized markets, each particular market tends to limit itself to one class of fungible assets, all the assets in the class having similar characteristics. For example, there are highly evolved markets for trading cut flowers, which are one class of fungible and there are highly evolved markets for trading the common stock of public companies, which is another class of fungible assets, but there is no one market in which both cut flowers and common stocks are traded. Because they are specialized, conventional markets are optimized for trading their own particular class of fungible assets and for the participants using the market.

Perhaps the most common economic transaction that occurs in a market is a sale, wherein the ownership of an asset is transferred permanently from one market participant to another. Sale transactions can be subdivided into two types: those transactions that settle quickly and those that settle at some point in the future. Markets where sale transactions are negotiated and settled shortly thereafter are known as cash markets or spot markets. Forward markets are markets where sale transactions are negotiated for settlement at some future date.

Other types of transactions, such as loans, occur in conventional markets as well. Markets where the transaction negotiated is a loan of a fungible asset are known as lending markets.

Complex transactions or strategies for a particular economic purpose can be synthesized through the execution of a combination of other transactions with different underlying economic purposes. For example a loan transaction can be created between two participants through the simultaneous sale of an asset in a spot market and the repurchase by the seller of the same asset in a forward market. This transaction structure or strategy is frequently referred to as a repurchase, repo, or sale and repurchase.

As explained, conventional markets tend to specialize in and facilitate just one type of transaction. For example, stock exchanges tend to restrict their activities to operating markets for spot sales of public equity securities. As a result of the specialization of markets by transaction type, transactions involving one particular fungible asset may occur in many different markets based on the type of transaction desired. For example, there is a spot sale market for IBM stock, a forward sale market for IBM stock, and a loan market for IBM stock, all of which are separate and independent of each other. Furthermore, there is often more than one market conducting the same type of transaction for a particular fungible asset as a result of factors such as the geographic location of participants, legal constraints, and competition between organized markets.

In highly evolved markets, complex transactions concerning a particular fungible asset are commonly embodied in a contract, such as a derivatives contract. Derivatives contracts commonly trade as securities in their own separate, specialized markets. Well known derivate structures include put options, call options, forward delivery contracts, futures, and swaps.

In current conventional markets, each transaction occurs independently of other transactions occurring in the same market or any other market, and transactions that involve more than one fungible asset in a single market, or that involve a single fungible asset in a plurality of markets, are typically not offered. There are some limited exceptions, such as the Inter-market Trading System operated by some United States stock exchanges, which provides automatic routing of an order entered at a member exchange to the exchange offering the best price at the instant the order is placed. This system and others like it route orders to markets dynamically based on then-available information, but are unable to guarantee that transactions can be executed on the same terms used to make the routing decision because the destination markets function discretely and autonomously. Similarly, within a particular market it is uncommon for the market to allow the execution of one transaction to be tied to the successful execution of another transaction in that particular or any other market.

Participants use organized markets and exchanges to execute trading strategies designed to achieve particular economic objectives. Trading strategies vary greatly in their structure and complexity. A very simple strategy may be executed in an instant in a single transaction involving a single fungible asset trading in a single market. A more complex strategy may require many transactions to be conducted in one or more markets over a broad time horizon.

As an example of a simple trading strategy, the owner of a particular asset may wish to convert that asset into a different asset. To accomplish this result, the owner may offer to exchange a specified quantity of the undesired asset for a specified quantity of a desired asset. For a more concrete example, consider the owner of 100 shares of IBM common stock who wishes to convert those shares into cash. This goal may be accomplished by offering to sell 100 shares of IBM at $90 per share in a stock market. In this example, the entire strategy could be executed in a single transaction occurring in a single market at a singular point in time.

In a more complex trading strategy example, a market participant may speculate that the price of a particular asset is about to rise. A trading strategy for exploiting this speculative expectation called a naked long position is to purchase the asset in the spot market at its current price, hold the asset until its price rises, and then sell it in the spot market at the higher price. Execution of this strategy involves two transactions that occur in a single marketplace at different points in time.

In another example, consider a market participant who speculates that the price of a particular asset that he or she does not own is about to fall. A trading strategy for exploiting this speculative expectation, called a short sale, is to sell the asset in the spot market, borrow the same asset in the lending market to settle the spot sale transaction, wait for the price of the asset to fall, then purchase the asset in the spot market at a lower price and deliver the purchased asset to the lender to unwind the loan. Execution of this strategy involves three transactions that are linked or related to each other: a sale transaction, a loan transaction, and a purchase transaction. Conventionally, these three transactions occur over a spread-out time horizon in two different markets and involve two different types of transactions (a sale and a purchase are both sale-type transactions).

Every trading strategy has attached to it a certain overall level of risk. Market theory typically defines risk as the variance in the expected economic return of the strategy. In some cases the variance many be favorable and in some cases the variance may be unfavorable. Economic theory teaches that an economically rational participant will expect the return from a particular trading strategy to be commensurate with its associated risk.

Risk can be divided into systemic and non-systemic risk. Systemic risk is that risk related to the mechanics of executing the strategy. The remaining risk is non-systemic and relates to the economic intent of the transaction. Economic theory teaches that the efficiency of a market improves when the systemic risk involved in participating in the market is reduced, and that the only risk a rational economic participant should willingly take is a non-systemic risk, and then only if it is warranted by the expected return.

The highly specialized nature of current conventional markets, coupled with their lack of contingent transactions within and across markets, adds to the systemic risk associated with the execution of some trading strategies. More specifically, conventional markets increase the systemic risk for trading strategies involving multiple linked transactions that should be executed contemporaneously with each other to achieve the intended economic effect of the strategy, and for trading strategies involving multiple linked transactions where the terms of one transaction are contingent on the terms of another transaction.

For example, in the short sale strategy described above the sale transaction should be contingent on the loan transaction, ideally occurring contemporaneously or not at all because a short sale should not occur if the underlying asset cannot be borrowed. Also, ideally the terms of the short sale transaction and the loan transaction should be contingently related to each other because the participant should only borrow as much of the underlying asset as was sold short and visa-versa. In current conventional markets, however, the short sale transaction occurs in one market, the lending transaction occurs in a different, independent market, and the two transactions are executed sequentially because conventional markets have no mechanism for linking transactions between two markets. Thus, executing the short sale strategy in a conventional market exposes the participant to increased systemic risk, for example the risk that the terms in the lending market will change in the interval between when the short sale transaction is completed and the loan transactions is completed. That is, the fee for borrowing the security may rise after the sales transaction completes, reducing the participant's overall economic benefit for the strategy. Furthermore, this systemic risk is completely unrelated to the economic intent of the transaction, which is to benefit from an anticipated fall in the spot market price of the underlying asset. The non-systemic risk in the transaction is the risk that the anticipated price movement will not occur as anticipated. In conventional markets, the systemic risk associated with uncertainty over the borrowing transaction is regarded as a cost of executing the strategy that the participant cannot avoid. To the extent that this cost can be reduced, however, the expected return of the transaction to the participant will be increased without any increase in the non-systemic and overall risk.

Short sale strategies are common practice in organized securities markets, in spite of the increased risk caused by the lack of integration between the spot sale and lending markets. In conventional markets, an intermediary, such as broker, is commonly used to execute these strategies. For a fee, the broker takes on the systemic risks of the transactions and offers the strategy as a bundled service. While intermediaries are effective, they are not economically efficient because intermediation adds costs to the strategy and because not all elements of the transactions are exposed to competitive pricing in a marketplace. For example, a broker acting as intermediate for a short seller typically borrows the stock from his or her own brokerage firm or the firm's customers, and charges lending fees arbitrarily set by the brokerage firm without competition from other potential stock lenders.

Accordingly, It is desirable to reduce costs of intermediation for certain trading strategies, such as linked, multi-transaction strategies. It is also desirable to reduce the systemic risks of such strategies. Further, it is desirable to expose the elements and transactions to competitive pricing, thus further reducing the costs of such strategies.

### SUMMARY OF THE INVENTION

In accordance with the principles of the present invention, a plurality, of linked markets enables a plurality of participants to negotiate and execute a plurality of linked transactions to permanently or temporarily transfer a specified quantity of a specified fungible asset among each other. A participant may specify that the execution of a particular transaction is contingent upon the contemporaneous execution of one or more other transactions, and a participant may specify that the quantity of fungible assets to be transferred in a particular transaction is dependent on the quantity of fungible assets to be transferred in another transaction.

Embodiments consistent with the present invention include a system, method, and computer program product for facilitating the sale of fungible assets comprising: receiving a plurality of linked orders, each linked order including a plurality of discrete orders for fungible assets, and for each discrete order, a set of parameters; matching a received linked order with at least one other linked order based upon the set of parameters for the received linked order and the set of parameters for the other linked order; and facilitating execution of the plurality of discrete orders of the matched received linked order contingent upon also facilitating execution of the plurality of discrete orders of the other linked order, wherein either all discrete orders are executed or none are executed.

Another embodiment consistent with the present invention is a system for managing linked markets for fungible assets comprising: a database comprised of entries of discrete order information, wherein each entry for discrete order information includes data identifying a fungible asset, data identifying a quantity of the fungible asset, data identifying a limit price for the fungible asset, data identifying the type of transaction desired, and data identifying a participant responsible for the entry, and wherein the fungible asset order information from the database is made available to a plurality of participants; and a computer for maintaining and querying the database and for receiving a linked order. In response to the linked order, the computer determines a plurality of discrete orders comprising the received linked order; based on the determination, locates in the database a set of stored discrete orders that match parameters of the determined plurality of discrete orders; upon locating matching stored discrete orders, facilitates execution of the plurality of discrete orders and the located set of stored matching discrete orders, according to the type of transaction, the fungible asset, the quantity, the limit price, and the participant parameters; and notifies participants concerning the plurality of discrete orders and the located set of stored matching discrete orders when execution is complete.

Many objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and together with the description, serve to further explain the invention.

FIG. 1 is diagram illustrating an example of a linked order representation consistent with the present invention;

FIG. 2 is a flow chart illustrating a process for matching linked orders consistent with the present invention;

FIG. 3 is a psuedocode listing illustrating a linked order matching algorithm consistent with the present invention;

FIG. 4 is a psuedocode listing illustrating part of the linked order matching algorithm of FIG. 3 in greater detail; and

FIG. 5 illustrates an exemplary computing system that can be used to implement embodiments of the invention.

### DETAILED DESCRIPTION

Systems consistent with the present invention create markets that are linked and integrated such that transactions in one market can be linked to one or more transactions in other markets through contingent relationships. The contingencies reduce the systemic risk associated with many trading strategies. For short sales for example, the spot market and the lending market for the underlying asset may be linked and orders with contingent relationships can be created in the two markets to effect the short sale with less risk.

One embodiment of a system consistent with the present invention provides a single market that allows participants to link together and execute more than one type of transaction and/or allows linked transactions involving more than one fungible asset. This embodiment allows a plurality of participants to place a plurality of linked orders (e.g., orders that are contingent on each other) in the market, and the embodiment matches the linked orders with one or more other linked orders and executes the orders subject to a specified set of business rules.

Embodiments consistent with the invention may be implemented using an overlay on existing conventional markets for the relevant assets and transactions or by creation of new, independent markets encompassing the relevant classes of fungible assets and types of transactions, without using the existing conventional markets.

In one embodiment, an operator, similar to the New York Stock Exchange, runs and regulates each market. In this embodiment, an operator is a legal entity possessing the ability to create and operate markets by implementing an instance of the invention in a particular jurisdiction. The legal and commercial context in which a particular instance of the invention operates may affect the details of each embodiment, but these implementation details are not crucial to the invention.

In one embodiment, each participant is a legal entity with the legal ability to participate in transactions. In some cases, a participant may be represented by one or more real or artificial agents who conduct transactions on behalf of the participant. A participant may participate in a plurality of markets.

In one embodiment, each linked market is a market in which one particular type of transaction to transfer a specified quantity of one particular fungible asset is negotiated between participants and executed according to a particular set of business rules. The market is linked or integrated with other markets such that transactions may be contingent among markets.

In one embodiment, a fungible asset is an asset that possesses characteristics making one instance of the asset generally interchangeable with another and transferable from one participant to another. Examples of classes of assets which normally meet these criteria are: public securities, agricultural commodities, mineral commodities, industrial commodities, standardized derivative contracts, and currencies. Other examples include loyalty program points and environmental rights. Real estate, in contrast, is not a fungible asset.

In one embodiment consistent with the invention, transactions involving only one particular fungible asset are negotiated in each market created. In this embodiment, the operator of a particular instance of the invention will typically create a plurality of linked markets by means of that instance. If, for example, an instance of the invention is used to embody a stock exchange, the operator could choose to create a separate market for each public issue traded on the exchange and link all these separate markets together to allow contingent trading among them. For another example, in a case where an instance of the invention is used to create a cut flower exchange the operator could choose to create linked markets for each variety of flower traded. Alternatively an operator could use a single instance of the invention to embody both a stock exchange and a cut flower exchange.

In one embodiment consistent with the invention, a transaction transfers a specified quantity of a specified fungible asset from one participant to one or more other participants, either permanently or temporarily, in exchange for consideration that includes a specified quantity of another specified fungible asset. Where the transfer of fungible assets is permanent, the transaction can be described as a sale. Where the transfer is temporary, the transaction can be described as a loan. Other types of transactions are also contemplated by the invention, and the exact type of transaction is not crucial to the invention. The type of asset provided in consideration is the currency of the transaction, and the quantity of consideration provided per unit of fungible asset transferred is the price. Where the transaction is a sale, one embodiment consistent with the invention enables the participants to negotiate the particular price at which a unit of a particular fungible assets will be permanently transferred from the seller the buyer. Where the transaction is a loan, one embodiment consistent with the invention enables participants to negotiate the fee or interest rate at which a unit of a particular fungible asset will be loaned to the borrower by the lender. Other embodiments consistent with the invention allow participants to negotiate the terms of other types of transactions.

In one embodiment consistent with the invention, the market operator specifies the following attributes for each linked market created:
(1) the particular fungible asset for which transactions are negotiated and executed in the market (e.g., IBM stock, long-stem roses, wheat futures, etc.),
(2) the fungible asset that constitutes the currency in which prices in that market are quoted (e.g., dollars, IBM stock, etc.),
(3) the terms of settlement for each transaction created in that market,
(4) the type of transaction negotiated and executed in that market (e.g., spot sales, forward sales, and loans, etc.),
(5) if the transactions negotiated in that market are loans, the term of the loan and the required collateral (e.g., 60 days and 10% of the loan value, etc.).

In one embodiment consistent with the present invention, participants create linked orders, which are comprised of one or more discrete orders and a linked order size, which is a positive quantity. Consistent with the invention, a linked order comprises one or more discrete market orders that are linked or contingent upon the other discrete orders in the linked order. In other words, the discrete orders are linked such that either all the discrete orders are filled or none of the orders are filled. The discrete orders may span several linked markets, and thus involve several different types of transactions for several different fungible assets and several different currencies. If a participant wishes to create a single discrete order with no contingent relationship to other discrete orders, then the participant can create a linked order containing a single discrete order and its linked order size.

More specifically, each discrete order is an expression of a commitment by the participant who created it to act in a specified capacity in a specified type of transaction conducted in the specified market involving the transference of a specified quantity of a specified fungible asset at a specified price denominated in a specific currency. In a transaction, a participant may act in the capacity of either a supplier or a consumer of a fungible asset. A discrete order expressing a commitment to supply a specified fungible asset in a transaction is called an offer and a discrete order expressing a commitment to consume a specified fungible asset is called a bid. In the case of a sale transaction, the participant who supplies the fungible assets is called the seller and the consuming participant is called the buyer. In the case of a loan transaction, the participant who supplies the fungible asset is called the lender and the consumer participant is called the borrower.

Reference will now be made in detail to exemplary embodiments of the invention, examples of which are illustrated in the accompanying drawings. Wherever convenient, the same reference numbers will be used throughout the drawings to refer to the same or like parts.

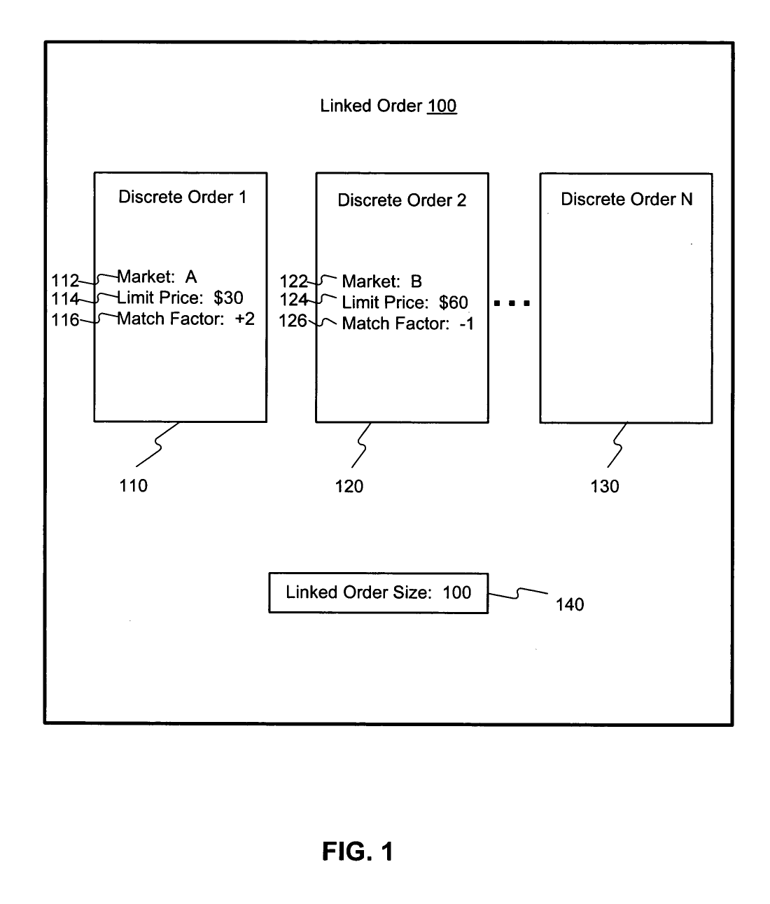

FIG. 1 is diagram illustrating an example of a linked order consistent with the present invention. As shown in FIG. 1, each discrete order 110, 120, and 130 in a linked order 100 may specify a set of parameters, such as a particular linked market, a particular limit price, and a particular match factor. For example, discrete order 110 specifies a linked market parameter 112 of market “A,” a limit price parameter 114 of $30, and a match factor parameter 116 of “+2.” The match factor parameter is one efficient way to identify the type of transaction and the quantity of fungible asset to be transferred in a transaction made pursuant to the discrete order. The participant creating the discrete order 110 may specify the linked market 112 as part of the order, and in one embodiment, the identity of the linked market 112 inherently specifies the fungible asset to be transferred, the currency of the transaction, and all other attributes associated with the specified linked market.

The limit price 114 means different things depending on the type of discrete order. In the case of an offer order, the limit price is the lowest price the participant is willing to accept in a transaction ensuing from the order, and the in the case of a bid order, it is the highest price the participant is willing to pay in a transaction ensuing from the order.

The match factor 116 is a number that specifies whether the discrete order is an offer or a bid and the quantity of fungible assets for transfer in a transaction ensuing from the discrete order for every unit of the enclosing linked order 100 matched. In one embodiment, a positive match factor 116 indicates an order that is an offer and a negative match factor 126 indicates an order that is a bid. An offer or bid could also be indicated in other ways without departing from the principles of the invention.

In one embodiment, the match factor provides a simple mechanism for linking the quantities of assets transferred in two or more discrete transactions that are part of a linked order 100. As shown in FIG. 1, for discrete order 1 10 included in linked order 100, the match factor 116 of “+2” means that for every one unit of the overall linked order 100 filled (out of the total linked order size 140), an offer of 2 units of fungible assets must be matched in the market specified by the discrete order 110. That is, a matching bid for 2 units of fungible assets for at least the limit price 114 of $30 must be found in market 112 “A”, as specified by the discrete order 110. Similarly, for discrete order 120, the match factor 126 of “−1” means that for every 1 unit of the linked order 100 matched, a bid of 1 unit of fungible assets must be matched in the market specified in the discrete order 120, in this case, market “B”. Thus, to completely match and fill linked order 100 (ignoring for this example all discrete orders other than discrete order 110 and discrete order 120), the system locates in market “A” a bid to buy 200 units of the market “A” asset for at least $30 per unit, and locates in market “B” an offer to sell 100 units of the market “B” asset for no more than $60 per unit. For example, market “A” may be a spot market for IBM common stock, and market “B” may be a 90-day futures market for silicon memory chips.

The economic objective of a participant making an offer, such as discrete offer order 110, may be to obtain as high a price as possible in any transaction ensuing from that offer, and the economic objective of any participant making a bid, such as discrete bid order 120, may be to pay as low a price as possible in any ensuing transaction. This would be typical rational economic behavior. In one embodiment consistent with the present invention, participants making offers indicate in the discrete order 110, by means of the limit price 114, the minimum price that they are willing to accept to enter into a transaction, such as $30 as shown. A higher price, however, is generally acceptable and desirable. Similarly, participants making bids indicate in a discrete order 120, by means of the limit price 124, the maximum price which they are willing to pay to enter into a transaction, such as $60 as shown, but a lower price is generally acceptable and desirable.

A linked market consistent with the present invention seeks to match the offer with the lowest limit price to the bid with the highest limit price, subject to any constraints imposed by linked order membership. Participants effect a negotiation by changing the limit prices associated with their discrete orders. Lowering the limit price of an offer, for example, increases the offer's competitiveness, while raising the limit price of a bid increases its competitiveness.

One embodiment of a market system consistent with the present invention matches and executes linked orders according to a particular set of business rules. The market system provides a plurality of participants with the ability to enter a plurality of linked orders as described above. When a participant creates a linked order, the market system attempts to match the new linked order with other linked orders previously created. In one embodiment, a particular linked order is matched with one or more other linked orders if all of the discrete orders comprising the particular linked order can be matched contemporaneously with other discrete orders that comprise the other linked orders being matched.

In one embodiment of a market system consistent with the invention a set of two or more linked orders may be matched when particular positive quantities of each particular linked order comprising the set can be combined such that:

(1) all of the discrete orders comprising all the linked orders in the set can be matched with each other taking into account the match factor and limit price constraints associated with those discrete orders, and

(2) the quantity of each linked order participating in the match is less than or equal to the linked order size of that linked order.

A particular discrete order can be matched with one or more other discrete orders where the following conditions are met:
(3) a particular offer in a particular linked market is matched with one or more bids in the same market, and similarly a particular bid in a particular linked market is matched with one or more offers in the same market,
(4) a particular offer with a particular limit price is matched with a particular bid if the limit price of the bid is higher than or equal to the limit price of the offer, and similarly a particular bid with a particular limit price is matched with an offer if the limit price of the offer is less than or equal to the limit price of the bid, and
(5) a particular offer is matched with one or more bids if the quantity of fungible assets available pursuant to the offer is equal to the absolute value of the match factor specified in that offer multiplied by the quantity of the enclosing linked order being matched, and similarly a particular bid is matched with one or more offers where the quantity of fungible asset desired pursuant the bid is equal to the absolute value of the match factor specified for that bid multiplied by the quantity of the enclosing linked order matched.

In other embodiments consistent with the invention, the order-matching criteria may differ from the above criteria. For example, a linked order may be matched if its discrete orders can be partially filled. In one embodiment consistent with the invention, the linked market system will automatically adjust the quantities of the other discrete orders in a linked order to proportionally equal the lowest quantity available in the market to partially fill one of the discrete orders. Matching criteria may vary as a result of: regulatory requirements in a jurisdiction, a desire to achieve different economic objectives or other reasons.

In one embodiment consistent with the invention, the following three constraints are applied to a set of linked orders to determine if that set meets the conditions required for matching:
(a) Match Factor Constraint: in each linked market, for all of the discrete orders being matched in that market, the supply of fungible assets equals the demand for fungible assets;
(b) Limit Price Constraint: in each linked market, for all of the discrete orders being matched in that market, the highest limit price among all the offers in that market is lower than or equal to the lowest limit price among all the bids in that market, and
(c) Linked Order Size Constraint: the quantity of each linked order participating in a match is less than or equal to that linked order's linked order size.

For a set of linked orders, one embodiment consistent with the invention tests compliance with these three constraints using the following algorithms.

Match Factor Constraint

Conditions 1, 3, and 5 above taken together imply that for particular quantities of particular linked orders to match, the sum of the quantity of fungible assets bid should be equal to the sum the quantity of fungible assets offered in each linked market. Alternatively stated, in each linked market the sum of the quantity of assets offered minus the sum of the quantity asset bid for should be equal to zero. This relationship is used to build a set of linear equations that are evaluated to determine if particular quantities of a particular set of linked orders can be matched.

These equations are formulated as follows:

Let n be the number of markets and let each market be labeled by the integers 1 through n.

Let Q be a particular set of linked orders of size m and let each linked order be labeled by the integers 1 through m.

Let each linked order be represented by a match factor vector of length n, a limit price vector of length n and a scalar quantity representing the linked order size. If the linked order contains a discrete order in market j let the value of element in the match factor vector be the match factor for that discrete order and let the value of element j in the limit price vector be the limit price for that discrete order; otherwise let the values of the match factor and limit price vectors be zero.

Let S be a matrix with m columns and n rows and let column j in S be the match factor vector for the linked order in element j of Q.

Let X be a vector of length m and let element j of X be the quantity of the linked order in element j of Q that is being matched.

Multiplying S by X results in a vector Y of length n, and element j of Y will represent the sum of all the quantities of fungible assets offered in market j minus all the quantities of fungible assets bid for in market j.

For a match to be valid, all of the elements in Y must be zero, all of the elements in X must be greater than or equal to zero, and each element j in X must be less than the linked order size for the linked order in element j of Q.

Given Q with X unknown, X can be solved for, under certain conditions, using techniques well known in linear algebra. The matrix S is defined by Q. In linear algebra, S is known as a system of homogenous linear equations and X is a solution to S. More specifically, linear algebra teaches that:
(1) if the number of linearly independent rows in S is greater than the number of columns in S, then no solution for S exists;
(2) if the number of linearly independent rows in S is exactly equal to the number of columns in S, then only one solution for S exists, called the trivial solution, for which all elements of X are zero;
(3) if the number of linearly independent rows in S is less than the number of columns in S, then an infinite number of unique, non-trivial solutions for S exist, and,
(4) if the number of linearly independent rows in S is one less than the number of columns in S, and the first element of X is set to 1, then a single unique non-trivial solution for S can be computed by conventional linear algebra techniques.

In the market context, a unique non-trivial solution to S is a necessary but not a sufficient condition for finding a valid match. This condition is not sufficient because a valid algebraic solution to S may include negative elements that are invalid in a real-life market context.

Limit Price Constraint

One embodiment consistent with the invention evaluates the limit price constraint using the following algorithm:

Let n, Q, m, and S be as defined above.

Let P be a matrix with m columns and n rows and let column j of P be the limit price vector for the linked order in element j of Q.

Let every element of P take the sign of the corresponding element of S so that the elements of P corresponding to an offer have at positive value and those corresponding to a bid have a negative value.

The limit price constraint has been met if in every row of P the absolute value of every negative value in a row is greater than or equal to every positive value in the row.

Linked Order Size Constraint

If a unique, non-trivial solution for S is found, and it does not contain any negative values, then the solution contains the relative proportions in which the linked orders in the set Q must be combined in order for the match to be valid. To compute the maximum absolute quantity of each linked order in Q that can be matched, the link order size constraint must be applied. One embodiment consistent with the invention applies the link order size constraint according to the following algorithm:

Let n, Q, m, S, and X be as defined above.

Let X contain a unique, non-trivial solution to S for a given set of linked orders in Q where no element in X is less than zero. In other words, let X represent a valid match.

Let a be the value of the largest element in X.

Divided every element of X by “a,” thereby scaling the largest value in X to 1.

Let Z be a vector of length m, and let element j of Z be equal to the linked order size for the linked order in element j of Q divided by element j of X.

Let b be the smallest element of Z.

Multiply every element of X by b.

After the multiplication, element j of X contains the absolute quantity of the linked order in element j of Q needed for a valid match of the linked order in Q.

The Linked Order Matching Process

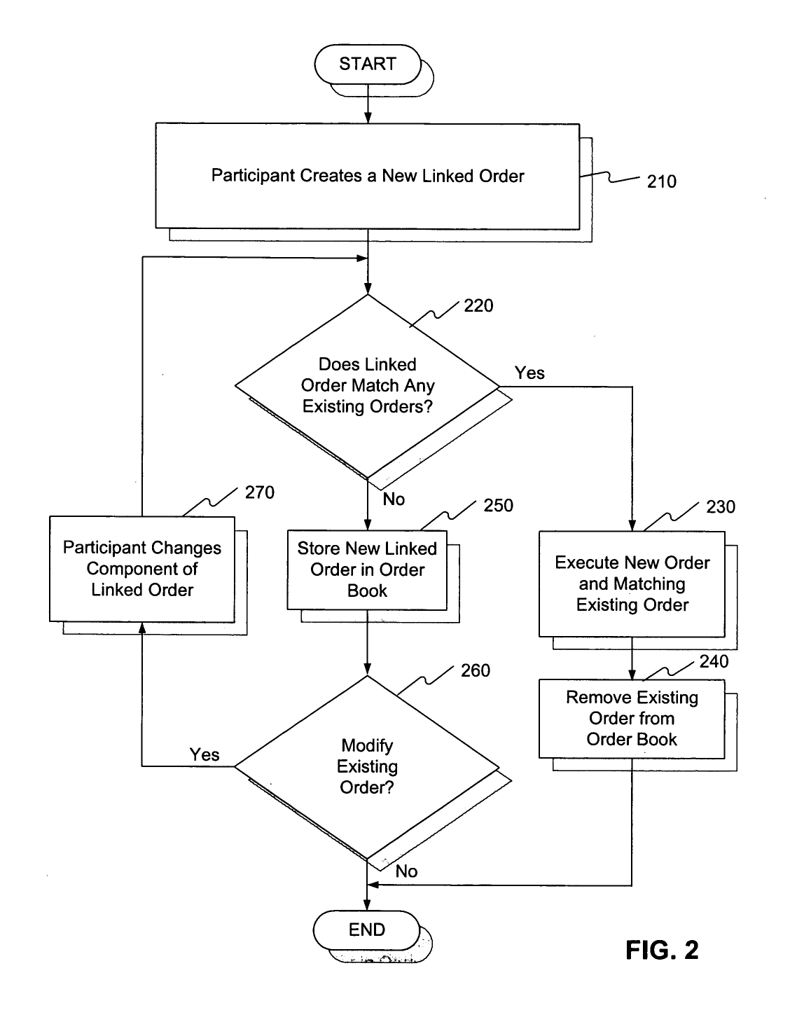

FIG. 2 is a flow chart illustrating a process for matching linked orders consistent with the present invention, typically carried out by a computer system. As shown in FIG. 2, the process begins with a participant creating a new linked order (step 210), such as the linked order shown in FIG. 1. Next, the process attempts to match the new linked order with other linked orders residing in its order book (step 220). In one embodiment consistent with the invention, the process matches the new linked order with the existing linked orders according to the rules and constraints described above. The order book is a database or other data repository that contains previously created linked orders that have not been matched and executed or cancelled. In one embodiment, the order book is maintained by the computer system.

If the new linked order cannot be matched with other linked order(s) from the order book (step 220, no), then the new linked order is added to the order book (step 250). If, on the other hand, the system finds a match for the new linked order among the linked orders in the order book (step 220, yes), then the process executes the new linked order and the matching existing order(s) (step 230), and removes the matched existing order(s) from the order book because the have been executed (step 240).

A participant may decide to modify a linked order stored in the order book (step 260, yes). In this case, the participant changes components of the linked order, such as the limit price (step 270), and submits the modified order to the processing system. In the embodiment shown, the system attempts to match the modified linked order with existing orders from the order book (step 220), just as it would a new linked order.

One of ordinary skill will recognize that the process shown in FIG. 2 may be changed by adding, deleting, or modifying steps without departing from the principles of the present invention. For example, participants may consult market information on existing linked orders in the order book, such as a quote or ticker tape, before creating a new linked order (step 210), thus increasing the chances of matching an existing order. As another example, a participant may cancel a linked order that has not yet been matched (not shown), unless the linked order is in the process of being matched or potentially matched. In another variation, a participant may modify a linked order by canceling the linked order and creating a new linked order that includes the desired changes, without having to first go through the other steps shown in FIG. 2.

Embodiments consistent with the invention may use many different algorithms to implement step 220 of FIG. 2 for matching a new linked order with a linked order or orders in the order book. The problem of finding a set of linked orders that match is complex because the number of unique combinations of linked orders grows at the rate of N factorial where N is the number of linked orders in the order book. This problem belongs to the class of problems known as combinatorial markets.

One embodiment of a linked order matching algorithm consistent with the invention accepts each new order and creates all possible combinations of the new order and the orders in the order book, evaluates each combination and selects those for which a match is possible, evaluates each possible matching combination against an economic objective function and selects the combination with the highest objective function value, if there is one. The complexity of this algorithm, however, grows at a hyper-geometric rate with the number of orders in the order book. Because of this hyper-geometric growth rate, this algorithm may be unfeasible for practical applications using current conventional computing systems.

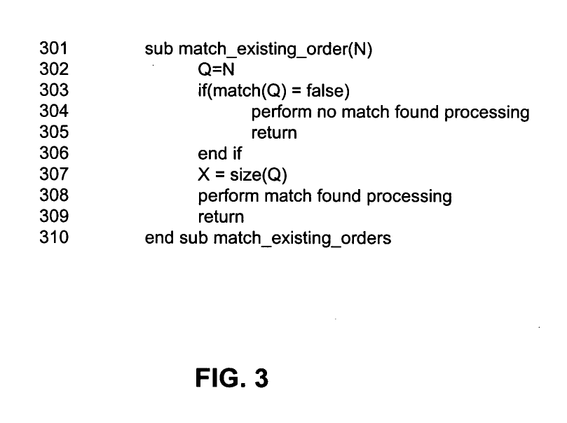

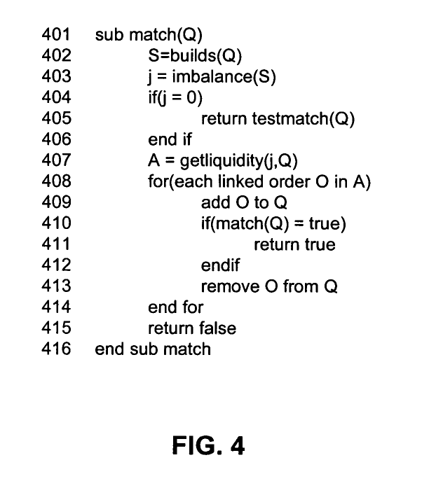

Another embodiment consistent with the invention uses a more practical but less thorough linked order matching algorithm. FIGS. 3 and 4 are psuedocode listings illustrating this embodiment of a linked order matching algorithm. The illustrated linked order matching algorithm does not necessarily find a solution even if one exists, and if a solution is found it may not necessarily be economically optimal. These disadvantages, however, are tradeoffs for an algorithm that completes processing in a reasonable amount of time and within the capacity of current computing systems, and any solution this algorithm finds will meet the matching criteria specified.

As shown in FIG. 3, the main routine of the algorithm functions as follows:

Let n, Q, m, S, and X be as defined above.

The definition and beginning of the main matching routine, “match existing orders,” is on line 301. Referring briefly back to FIG. 2, when a participant creates a new linked order (step 210), a system consistent with the invention executes the main matching routine with the new linked order passed to the routine as parameter N.

Referring again to FIG. 3, at line 302, the match_existing_orders routine creates the Q vector and initializes it to contain N.

At line 303 the match_existing_orders routine calls the subroutine “match” and passes Q as a parameter. The “match” subroutine returns a boolean result, which is tested. If subroutine match returns false, then the subroutine algorithm was unable to find a set of linked orders in the order book that match the new linked order N. In this case, at line 304 the match_existing_orders routine performs processing related to the condition where no match is found, and exits at line 305.

If, at line 303, subroutine match returns true, then Q contains a set of linked orders that can be matched with the new linked order N. In this case, processing jumps to line 307, where the size subroutine is called with Q passed as a parameter. In the manner described above, the size subroutine computes the absolute quantities of the linked orders in Q that can be matched and returns them in X.

At line 308, the match_existing_orders routine performs processing appropriate after finding a valid match. See, for example, steps 230 and 240 of FIG. 2.

At line 309, the match_existing_orders main routine exits.

FIG. 4 is psuedocode describing the “match” subroutine in greater detail. As shown in FIG. 4, at line 401 the match subroutine begins processing with Q as the input parameter.

At line 402, the match subroutine calls the “builds” routine, passing Q as a parameter. The builds routine computes the S matrix for the Q vector, which was passed as input to the match subroutine. The builds routine computes the S matrix as described above.

At line 403, the match subroutine calls the imbalance routine with S as the input parameter. The imbalance routine examines the match factors in each row of S sequentially and returns either: (1) the row number (as a positive integer) of the first row it finds having one or more offers but no bids, (2) the row number times −1 (i.e., a negative integer) of the first row found having one or more bids but no offers, or (3) zero, if no unbalanced row is found.

At line 404, the match subroutine tests the result of the call to the imbalance routine to determine whether it found an imbalance.

If no imbalance was found, then at line 405 the routine testmatch is called with Q provided as input and the match subroutine exits, returning the results of the call to the testmatch routine. The routine testmatch takes the input Q vector and determines whether Q meets the match factor constraint, as described above. If the match factor constraint is met, the testmatch routine returns true; otherwise it returns false.

At line 407, the match subroutine creates a vector A by calling the getliquidity routine with j and Q passed as parameters. For the getliquidity routine call, the absolute value of j represents the market in which an imbalance of bids or offers was found. If j is positive, then the getliquidity routine fetches all the linked orders in the order book that have bids in linked market j and sorts them into descending order by bid price. On the other hand, if j is negative, then the getliquidity routing fetches all of the linked orders in the linked order book that have offers in market j times −1 (i.e., −j, or stated another way, offers in market k where k is the absolute value of j) and sorts them in ascending order by limit price. Using Q, getliquidity then removes any linked order from A that is already a member of Q and removes any linked order that would violate the limit price constraint in any market if added to Q. The getliquidity routine results are placed in A

At line 408, the match routine begins a loop that extracts the elements of A one at a time, in order, and places them in O.

At line 409, a particular O is added to the end of the Q vector.

At line 410, the match routine calls itself recursively with the new Q vector passed as input, and the result is tested. The recursion loop terminates when a Q vector has been constructed that meets the requirement that there be at least one bid in every market that has at least one offer, and that there be at least one offer for any market that contains one or more bids. If these condition are met a match may be possible if other constraints are met.

At line 411, the match subroutine returns true and exits if the recursive call to the match subroutine returned true.

At line 413, the O added to Q at line 409 is removed because its addition did not resulted in a valid match.

At line 414, the loop structure beginning at line 408 ends, and another iteration begins at line 408 if there are more elements in A to process.

If subroutine match reaches line 415, then there are no more linked orders in A to process and no more new candidate match sets can be created and tested. At line 415, the match subroutine returns false to indicate that no match has been found.

In one embodiment consistent with the present invention, the contents of the order book must remain stable while the linked order matching algorithm is running. In other embodiments consistent with the invention, the order book may change while the linked order matching algorithm is running. In this embodiment, care should be taken, however, to ensure that the linked orders comprising a match set are still outstanding prior to executing transactions as a result of the match. In other words, the system should ensure that a participant has not cancelled or modified a linked order before the system executes that order.

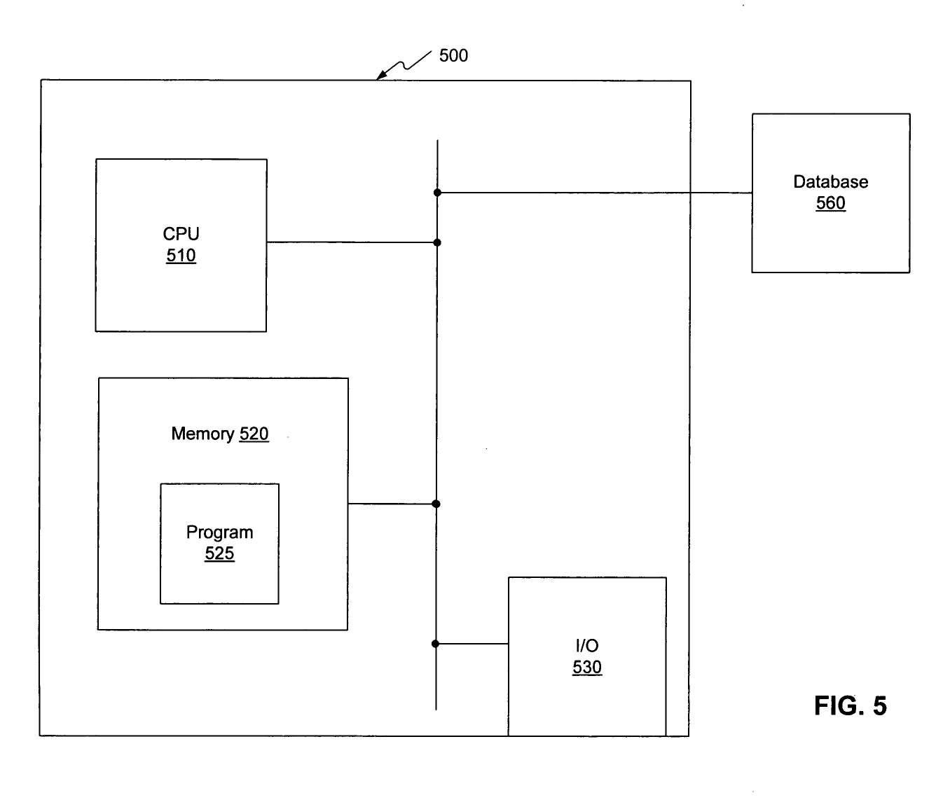

FIG. 5 illustrates an exemplary computing system 500 that can be used to implement embodiments of the invention. The components and arrangement, however, are not critical to the invention.

System 500 includes a number of components, such as a central processing unit (CPU) 510, a memory 520, an input/output (I/O) device(s) 530, and a database 560 that can be implemented in various ways. For example, an integrated platform (such as a workstation, personal computer, laptop, etc.) may comprise CPU 510, memory 520 and I/O devices 530. In such a configuration, components 510, 520, and 530 may connect through a local bus interface and access to database 560 (implemented as a separate database system) may be facilitated through a direct communication link, a local area network (LAN), a wide area network (WAN) and/or other suitable connections.

CPU 510 may be one or more known processing devices, such as a microprocessor from the Pentium family manufactured by Intel™, or a mainframe-class processor. Memory 520 may be one or more storage devices configured to store information used by CPU 510 to perform certain functions related to embodiments of the present invention. Memory 520 may be a magnetic, semiconductor, tape, optical, or other type of storage device. In one embodiment, memory 520 includes one or more programs 525 that, when executed by CPU 510, perform various processes consistent with the present invention. For example, memory 520 may include a linked order matching program 525 that, when executed by CPU 510, determines whether a new linked order matches any existing linked orders. Memory 520 may also include other programs that perform other functions consistent with embodiments of the invention.

Methods, systems, and articles of manufacture consistent with the present invention are not limited to programs configured to perform dedicated tasks. For example, memory 520 may be configured with a program 525 that performs several functions when executed by CPU 510. That is, memory 520 may include a program that both allows participants to modify their existing linked orders and that searches database 560 for matching linked orders stored in the order book. Alternatively, CPU 510 may execute one or more programs located remotely from system 500. For example, system 500 may access one or more remote programs that, when executed, perform functions related to embodiments of the present invention. The configuration and number of programs implementing processes consistent with the invention are not critical to the invention.

Memory 520 may be also be configured with an operating system (not shown) that performs several functions well known in the art when executed by CPU 510. By way of example, the operating system may be Microsoft Windows™, Unix™, Linux™, an Apple™ operating system such as MAC OSX™, Personal Digital Assistant operating system such as Microsoft CE™, or other operating system. The choice of operating system, and even to the use of an operating system, is not critical to the invention.

I/O device(s) 530 may comprise one or more input/output devices that allow data to be received and/or transmitted by system 500. For example, I/O device 530 may include one or more input devices, such as a keyboard, touch screen, mouse, microphone, and the like, that enable data to be input from a user. Further, I/O device 530 may include one or more output devices, such as a display screen, printer, speaker devices, and the like, that enable data to be output or presented to a user. The configuration and number of input and/or output devices incorporated in I/O device 530 are not critical to the invention.

Database 560 may comprise one or more databases that store information and are accessed and managed through system 500. By way of example, database 560 may be an Oracle™ database, a Sybase™ database, or other relational database. One embodiment described above uses database 560 as the order book. Systems and methods of the present invention, however, are not limited to separate databases or even to the use of a database as other organized collections of data or memory systems will serve as well.

Although the preceding embodiments of the invention may have been described in terms of components such as commercially available data processing apparatus, data communication facilities provided by one or more common carriers, computer program products including code for causing a processor to perform a process, commercially available application software, conventional databases, unique application software developed specifically to embody certain aspects of the invention, commonly available services provided by financial institutions, and a legal framework embodied by contracts and agreements between the legal entities comprising, operating, and using systems and methods consistent with the invention, one of ordinary skill will recognize that other embodiments consistent with the present invention may be easily formed using more, fewer, or different components and by combining the functions of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of facilitating the sale of fungible assets comprising:
receiving a plurality of linked orders, each linked order including a plurality of discrete orders for fungible assets, and for each discrete order, a set of parameters;
matching a received linked order with at least one other linked order based upon the set of parameters for the received linked order and the set of parameters for the other linked order; and
facilitating execution of the plurality of discrete orders of the matched received linked order contingent upon also facilitating execution of the plurality of discrete orders of the other linked order, wherein either all discrete orders are executed or none are executed.

2. The method of claim 1, wherein the plurality of discrete orders of the matched received linked order are executed contemporaneously with the plurality of discrete orders of the other linked order.

3. The method of claim 1, wherein the set of parameters for a discrete order includes parameters specifying a market, a limit price, and a quantity.

4. The method of claim 1, wherein the plurality of linked orders includes discrete orders for two or more different fungible assets that trade in two or more different markets.

5. The method of claim 1, further comprising:
storing a received linked order in an order book if the matching step fails to find a match for the received linked order; and
matching the stored received linked order with a subsequently received linked order.

6. A system for facilitating the sale of fungible assets comprising:
means for receiving a plurality of linked orders, each linked order including a plurality of discrete orders for fungible assets, and for each discrete order, a set of parameters;
means for matching a received linked order with at least one other linked order based upon the set of parameters for the received linked order and the set of parameters for the other linked order; and
means for facilitating execution of the plurality of discrete orders of the matched received linked order contingent upon also facilitating execution of the plurality of discrete orders of the other linked order, wherein either all discrete orders are executed or none are executed.

7. The system of claim 6, wherein the plurality of discrete orders of the matched received linked order are executed contemporaneously with the plurality of discrete orders of the other linked order.

8. The system of claim 6, wherein the set of parameters for a discrete order includes parameters specifying a market, a limit price, and a quantity.

9. The system of claim 6, wherein the plurality of linked orders includes discrete orders for two or more different fungible assets that trade in two or more different markets.

10. The system of claim 6, further comprising:
means for storing a received linked order in an order book if the matching step fails to find a match for the received linked order; and
means for matching the stored received linked order with a subsequently received linked order.

11. A computer program product for facilitating the sale of fungible assets including code for causing a processor to perform a process comprising:
receiving a plurality of linked orders, each linked order including a plurality of discrete orders for fungible assets, and for each discrete order, a set of parameters;
matching a received linked order with at least one other linked order based upon the set of parameters for the received linked order and the set of parameters for the other linked order; and
facilitating execution of the plurality of discrete orders of the matched received linked order contingent upon also facilitating execution of the plurality of discrete orders of the other linked order, wherein either all discrete orders are executed or none are executed.

12. The computer program product of claim 11, wherein the plurality of discrete orders of the matched received linked order are executed contemporaneously with the plurality of discrete orders of the other linked order.

13. The computer program product of claim 11, wherein the set of parameters for a discrete order includes parameters specifying a market, a limit price, and a quantity.

14. The computer program product of claim 11, wherein the plurality of linked orders includes discrete orders for two or more different fungible assets that trade in two or more different markets.

15. The computer program product of claim 11, wherein the process further comprises:
storing a received linked order in an order book if the matching step fails to find a match for the received linked order; and
matching the stored received linked order with a subsequently received linked order.

16. A system for managing linked markets for fungible assets, comprising:
a database comprised of entries of discrete order information, wherein each entry for discrete order information includes data identifying a fungible asset, data identifying a quantity of the fungible asset, data identifying a limit price for the fungible asset, data identifying the type of transaction desired, and data identifying a participant responsible for the entry, and wherein the fungible asset order information from the database is made available to a plurality of participants; and
a computer for maintaining and querying the database and for receiving a linked order, and in response to the linked order, the computer:
determining a plurality of discrete orders comprising the received linked order;
based on the determination, locating in the database a set of stored discrete orders that match parameters of the determined plurality of discrete orders;
upon locating matching stored discrete orders, facilitating execution of the plurality of discrete orders and the located set of stored matching discrete orders, according to the type of transaction, the fungible asset, the quantity, the limit price, and the participant parameters; and
notifying participants concerning the plurality of discrete orders and the located set of stored matching discrete orders when execution is complete.

17. The system of claim 16, wherein the plurality of discrete orders and the set of stored matching discrete orders are executed contemporaneously.

18. The system of claim 16, wherein the plurality of discrete orders comprising the received linked order include data identifying at least two different fungible assets.

19. The system of claim 16, wherein each entry for discrete order information further includes data identifying a linked order that includes the discrete order.

20. The system of claim 16, wherein if a match is not located, the computer stores entries of discrete order information for the plurality of discrete orders comprising the received linked order in the database.

21. A method for facilitating transactions for fungible assets, comprising:
receiving a plurality of linked orders, each linked order including a plurality of discrete orders to buy and/or sell fungible assets, and for each discrete order a set of parameters;
determining, as a function of the parameters of the discrete orders corresponding to each of the linked orders, a matching set of linked orders;
determining an execution set of the matching set of linked orders such that all discrete orders corresponding to each of the linked orders of the matching set will be executed; and
facilitating execution of the execution set.
